(19) United States
(12) Patent Application Publication
(10) Pub. No.: US 2005/0222859 A1
(43) Pub. Date: Oct. 6, 2005

(54) Device and method for integrated management of rent out washing machine

(75) Inventor: Mi Kyung Ha, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/065,303

(22) Filed: Feb. 25, 2005

(30) Foreign Application Priority Data
Apr. 1, 2004 (KR) P2004-0022543

(51) Int. Cl. G06F 17/60; D06F 1/00

(52) U.S. Cl. 705/1

(57) ABSTRACT

Device and method for integrated management of rent out washing machines, for effective integrated management of rent out washing machines, in which the washing machines rent out to a particular place, such as dormitory, are managed of details of use for each user, and state information for each rent out washing machine by using a communication terminal (PC) or a managing server far from the washing machines. According to this, the central integrated management of the rent out washing machines by means of PC or server, not only resolves the inconvenience and difficulty in purchase, installation, and movement of the washing machine in a position of the users, but also enables to use washing machines of new models anytime. Moreover, a variety of requirements of the consumer can be met in a position of person in the business (manager), and in turn the person can enjoy increase of income.

### CROSS-REFERENCE TO RELATED APPLICATION

This application claims the benefit of Korean Application No. P2004-0022543 filed on Apr. 1, 2004, which is hereby incorporated by reference as if fully set forth herein.

### BACKGROUND OF THE INVENTION

1. Field of the Invention

The present invention relates to washing machines, and more particularly, to device and method for integrated management of rent out washing machines, for effective integrated management of rent out washing machines.

2. Discussion of the Related Art

In general, the washing machine is one of home appliances provided to a home and used the most widely, for removing dirt from laundry by softening action of detergent, friction of circulating water caused by rotation, and impact to the laundry.

In the washing machines, there are many kinds of products having a variety of washing types, such as pulsator type, agitator type, drum type, and so on applied thereto, respectively. Particularly, for washing machines for business purposes, such as rent out washing machines, the drum type washing machines are used, mostly.

Or, depending on separation of washing tub, and spinning tub, there are separated type, and full automatic type washing machines.

In the separated type, the washing tub and the spinning tub are separated from each other, so that the washing tub performs washing or rinsing as a pulsator on a bottom thereof alternates to cause water circulation, and the spinning tub extracts water from the laundry by centrifugal force.

In the meantime, the full automatic type washing machine has the spinning tub placed in the washing tub. In washing, the pulsator on the bottom rotates, to washing or rinse, and in water extraction, the spinning tub having perforation spins for water extraction.

Most of the washing machines are designed such that the user sets washing conditions, such as a washing time period, a rinsing time period, a spinning time period, and so on, properly according to cloth properties and amount of laundry.

Or alternatively, the user may use a plurality of washing course programs stored in a memory provided for convenience of the user, such as centrifugal washing, preliminary washing, vibratory washing, soaked washing, wool washing, and so on.

It is recent trend that various home appliances including the washing machine are built-in multi-household houses, apartment houses, business buildings, and school dormitories.

However, the built-in washing machines have many problems in that plumbing and re-installation of the washing machine are difficult when people moves house.

Moreover, in a case when a person is to marry, who lives at dormitory, or the like, the person is involved in a cumbersome situation in which the person, in general, is required to buy a new washing machine and dispose of an old washing machine the person has used.

### SUMMARY OF THE INVENTION

Accordingly, the present invention is directed to device and method for integrated management of rent out washing machines that substantially obviates one or more problems due to limitations and disadvantages of the related art.

An object of the present invention is to provide device and method for integrated management of rent out washing machines, which enables users not to require to buy washing machines individually.

Another object of the present invention is to provide device and method for integrated management of rent out washing machines, in which an effective integrated management of washing machines is made for users to use the washing machines, conveniently whenever required.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a device for integrated management of rent out washing machines includes a plurality of rent out washing machines, and a charging device connected to the plurality of rent out washing machines, for controlling operation of one of the rent out washing machines the user intends to use, if washing cost is paid for using the one rent out washing machine.

In another aspect of the present invention, a device for integrated management of rent out washing machines includes a plurality of rent out washing machines, a charging device for charging washing cost of the rent out washing machine, and a communication terminal connected to the plurality of rent out washing machines and the charging device, for controlling operation of one of the rent out washing machines the user intends to use, if the washing cost is paid through the charging device for using the one rent out washing machine.

In another aspect of the present invention, a device for integrated management of rent out washing machines includes a plurality of rent out washing machines, a charging device for charging washing cost of the rent out washing machine, a managing server for operating a web site for providing remote control of the rent out washing machines and integrated management service, and a communication terminal accessible to the managing server through a communication network for enabling the remote control and integrated management of the rent out washing machines, and connected to the plurality of rent out washing machines and the charging device, for controlling operation of one of the rent out washing machines the user intends to use, if the washing cost is paid through the charging device for using the one rent out washing machine.

In another aspect of the present invention, a method for integrated management of rent out washing machines includes the steps of receiving washing conditions of washing object to be washed from one of the rent out washing machines selected by the user, calculating washing cost of the rent out washing machine with reference both to product information on the rent out washing machine selected by the user, and the washing conditions received, and controlling to start operation of the rent out washing machine if the washing cost is paid.

In another aspect of the present invention, a method for integrated management of rent out washing machines includes the steps of making access to a managing server which provides remote control, and integrated management services of the rent out washing machines, receiving product information on the rent out washing machine selected by a user, and washing conditions of a washing object to be washed if the user intending to access presently is a subscriber registered already, calculating washing cost of the rent out washing machine with reference both to the product information on the rent out washing machine and the washing conditions received, and controlling to start operation of the rent out washing machine if the washing cost is paid.

In another aspect of the present invention, a method for integrated management of rent out washing machines includes the steps of receiving washing conditions of a washing object to be washed from one of the rent out washing machines selected by the user, determining the present status of use of the rent out washing machine selected by the user, searching for a rent out washing machine having product information the same with rent out washing machine selected by the user, if there is the rent out washing machine having product information the same with the rent out washing machine selected by the user, calculating washing cost of the rent out washing machine with reference both to the product information on the rent out washing machine and the washing conditions received, and controlling to start operation of the rent out washing machine if the washing cost is paid.

In another aspect of the present invention, a method for integrated management of rent out washing machines includes the steps of making access to a managing server which provides remote control, and integrated management services of the rent out washing machines, receiving details of use, and state information of the rent out washing machine the user used if the user intending to access presently is a subscriber registered already, renewing the details of use for each of users according to the details of use of the rent out washing machine received, and making fault diagnosis of the rent out washing machines through the state information on the rent out washing machines received.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a diagram showing a system of a device for integrated management of rent out washing machines in accordance with a preferred embodiment of the present invention;

FIG. 2A illustrates a block diagram showing a system of one of the rent out washing machines in FIG. 1;

FIG. 2B illustrates a block diagram showing a system of the charging device in FIG. 1;

FIG. 3 illustrates a diagram showing a system of a device for integrated management of rent out washing machines in accordance with a second preferred embodiment of the present invention;

FIG. 4 illustrates a block diagram showing a system of the communication terminal in FIG. 3;

FIG. 5 illustrates a diagram showing a system of a device for integrated management of rent out washing machines in accordance with a third preferred embodiment of the present invention;

FIG. 6 illustrates a flow chart showing the steps of a method for integrated management of rent out washing machines in accordance with a preferred embodiment of the present invention;

FIG. 7 illustrates a flow chart showing the steps of a method for integrated management of rent out washing machines in accordance with another preferred embodiment of the present invention; and

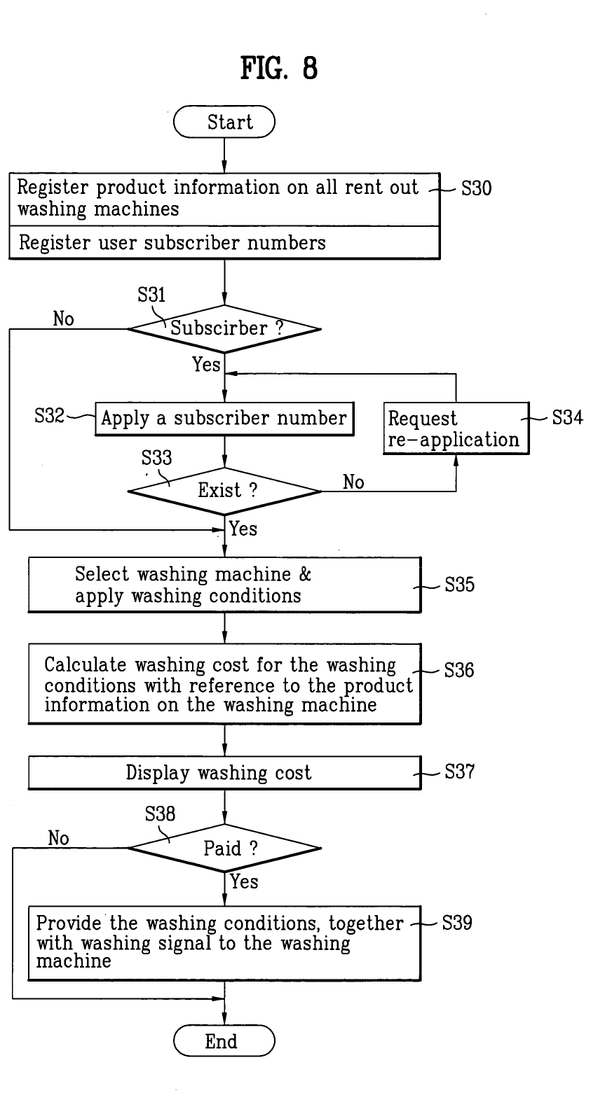

FIGS. 8 and 9 illustrate flow charts each showing the steps of a method for integrated management of rent out washing machines in accordance with another preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

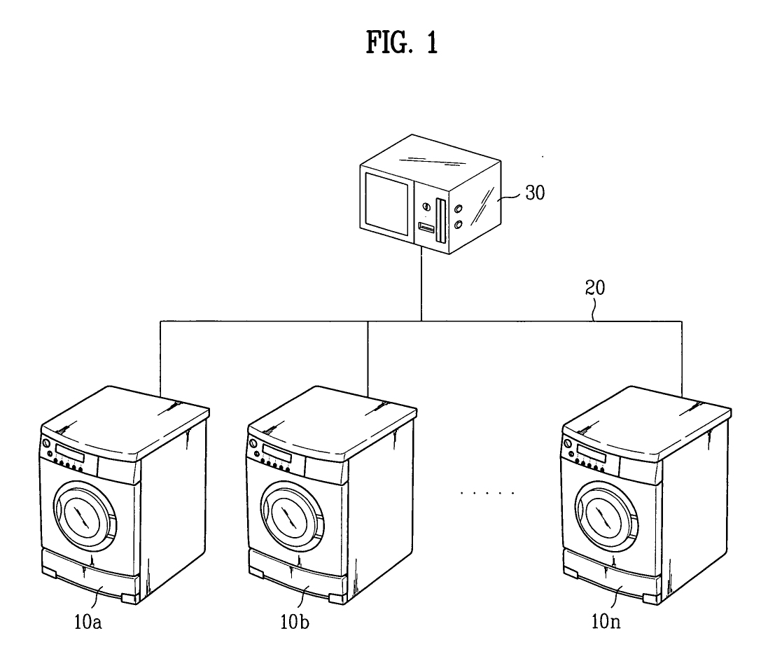

FIG. 1 illustrates a diagram showing a system of a device for integrated management of rent out washing machines in accordance with a preferred embodiment of the present invention.

Referring to FIG. 1, the device for integrated management of rent out washing machines includes a plurality of rent out washing machines 10a˜10n, and a charging device 30 interfaced with the rent out washing machines through communication means 20.

The communication means 20 may be of a radio communication type, such as bluetooth, PLC (Power Line Communication), and ubiquitous, or of a wire communication type, such as RS-232C, and a modem.

Each of the rent out washing machines 10a˜10n and the charging device 30 have data input/output ports (not shown) for the communication means 20 to make bilateral data communication.

According to this, the rent out washing machines 10a˜10n and the charging device 30 are enabled to make data communication through the radio type or wire type communication means 20.

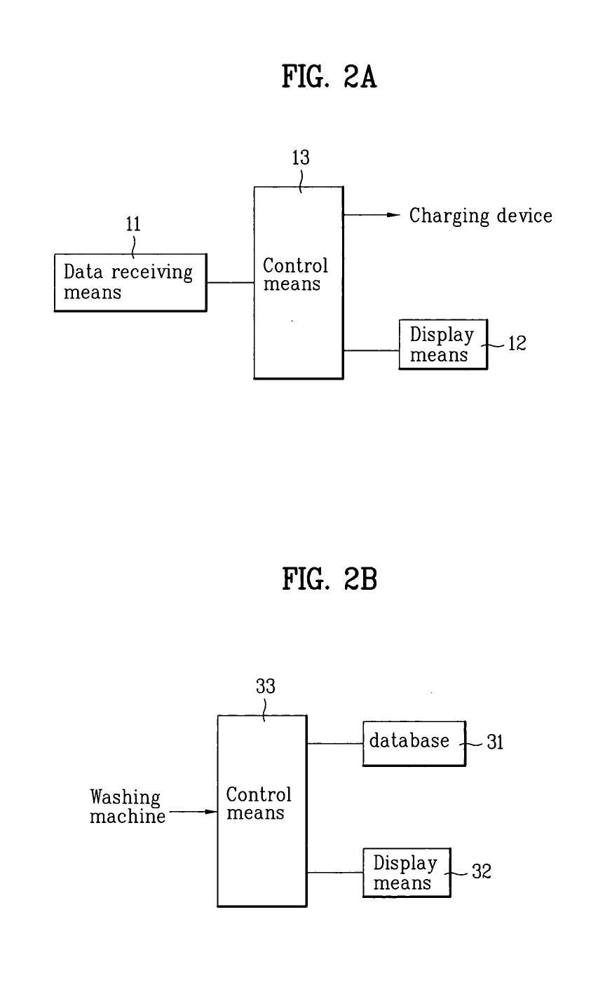

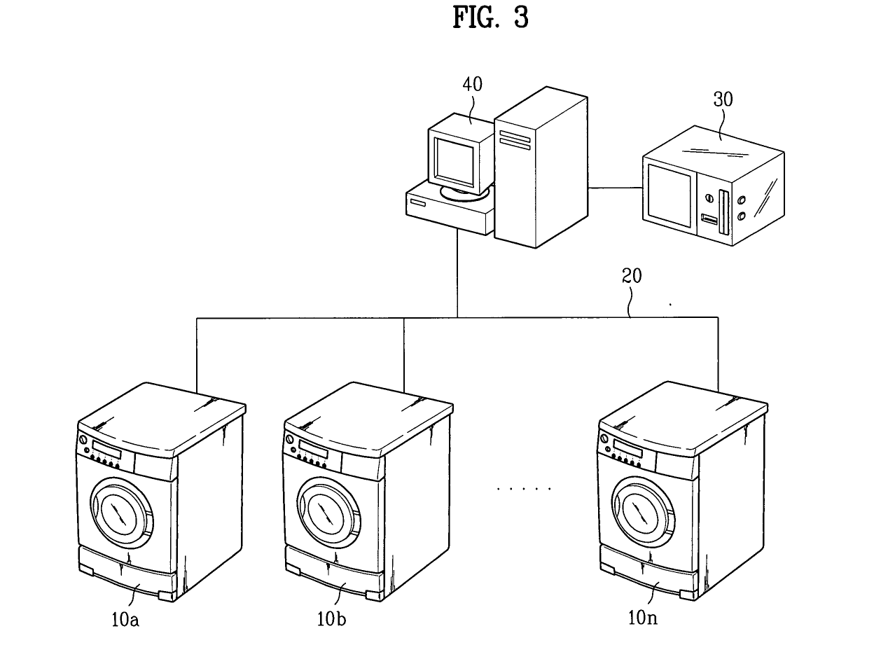

Referring to FIG. 2A, each of the rent out washing machines includes data receiving means 11 for receiving washing conditions of washing objects, display means 12 for displaying a state of washing progress, and control means 13 for transmission of the washing condition to the charging device 30 if the washing condition is received through the data receiving means 11, together with a serial number of the washing machine, and controlling washing operation in response to a driving signal of the washing condition from the charging device 30.

The charging device 30 includes means for recognizing at least one of paying means, such as a credit card, a cellular phone, and so on.

Moreover, referring to FIG. 2B, the charging device 30 includes a database 31 having product information on the rent out washing machines 10a˜10n stored therein, control means 33 for calculating a washing cost for the washing condition with reference to the product information in the database 31 upon reception of the serial number, and the washing condition from the rent out washing machine 10a˜10n, and providing a washing signal to the rent out washing machine 10a˜10n upon finishing charging, and reception of the washing cost, and display means 32 for displaying the washing cost calculated at the control means 33.

The charging device 30 has product information on the rent out washing machines stored in the database 31 in advance, such as serial numbers of the rent out washing machines, kinds of the washing machines (drum types, agitator types, pulsator types, drying capability, and so on), washing capacities (5 kg, 6 kg, - - - , 13 kg, and so on), kinds of motors (BLDC motors, induction motors, SRM motors, and so on), and so on.

Above system enables the user to select one of the rent out washing machine 10a˜1-n, and apply washing conditions proper to a washing object intended to wash to the data receiving means 11.

The washing conditions the user applies may be a clothes amount to be washed (low, low-medium, medium, medium-high, or high), a washing course program (a centrifugal washing, a preliminary washing, vibratory washing, or soaked washing), a washing time period, a number of washing, a number of rinsing, a spinning time period, a number of spinning, and so on.

Of course, if the user does not apply the washing conditions one by one, but selects automatic washing, the control means 13 checks the clothes amount automatically, and determines the washing conditions proper to the clothes amount.

Then, upon reception of the washing conditions, the rent out washing machine 10a˜10n provides the washing conditions to the charging device 30 through the communication means 20, together with the serial number of the washing machine.

Upon reception of the serial number, and the washing conditions from one of the rent out washing machines 10a˜10n through the communication means 20, the charging device 30 reads the product information on the rent out washing machine of the serial number from the database 31, and calculates washing cost with reference to the washing conditions.

Then, the charging device 30 displays the washing cost on the display means 32, and, if the washing cost is paid by the user, provides a washing signal to the rent out washing machine 10a˜10n through the communication means 20.

Upon reception of the washing signal from the charging device 30, the rent out washing machine 10a˜10n, recognizing the washing signal as a washing start order, performs washing according to the user's washing conditions.

Or alternatively, by storing subscriber numbers in the database 31, subscriber based management may be made, in which use of the rent out washing machine 10a˜10n is permitted only to the subscribers stored in the charging device 30.

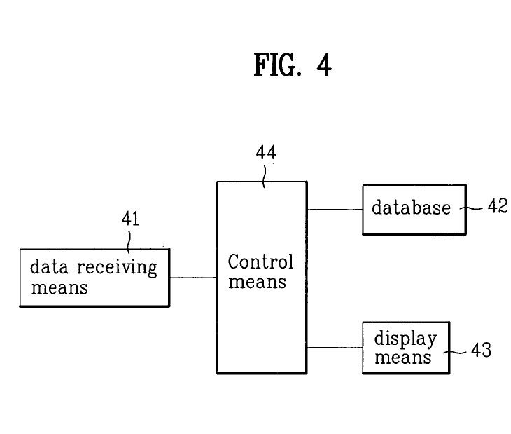

FIG. 3 illustrates a diagram showing a system of a device for integrated management of rent out washing machines in accordance with a second preferred embodiment of the present invention.

Referring to FIG. 3, the device for integrated management of rent out washing machines includes a plurality of rent out washing machines 10a˜10n, a communication terminal 40 interfaced with the rent out washing machines 10a˜10n through communication means 20, and a charging device 30 connected to the communication terminal 40 for charging washing cost of the rent out washing machines 10a˜10n.

The communication means 20 may be of a radio communication type, such as bluetooth, PLC (Power Line Communication), or ubiquitous, or of a wire communication type, such as RS-232C, or a modem.

Each of the rent out washing machines 10a˜10n and the communication terminal 40 have data input/output ports (not shown) for the communication means 20 to make bilateral data communication.

According to this, the rent out washing machines 10a˜10n and the communication terminal 40 are enabled to make data interface through the radio type or wire type communication means 20.

The communication terminal 40 may be a PC, or a notebook computer.

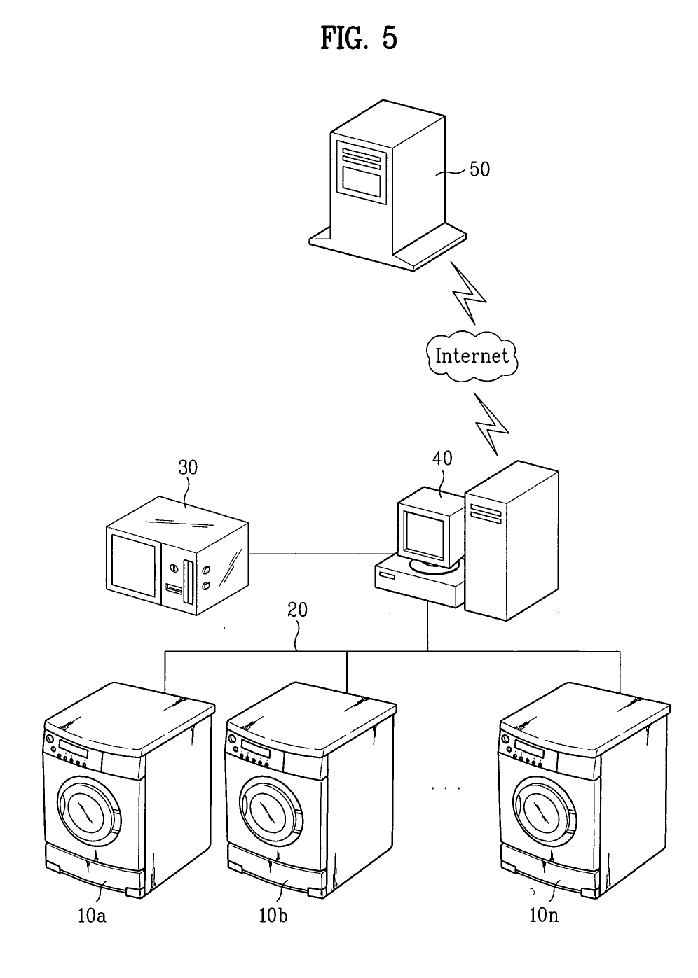

Referring to FIG. 4, the communication terminal 40 includes a database 42 having product information on the rent out washing machine 10a˜10n connected through the communication means 20, data receiving means 41 for selecting one from the rent out washing machines 10a˜10n intended to use, and receiving washing conditions of washing objects intended to wash, display means 12 for displaying images related to various washing control and the washing cost, and control means 44 for calculating washing cost with reference both to the product information stored in the database 42 and the washing condition if the user applies the rent out washing machine intended to use and the washing conditions through the data receiving means 41, and providing a washing signal to the rent out washing machine if charging, and reception of the washing cost is finished.

The communication terminal 40, to be used as user data input means for the rent out washing machines 10a˜10n, provides a user interface screen related to washing control for the user to apply the washing conditions of the rent out washing machines 10a˜10n.

Moreover, the communication terminal 40 has product information on the rent out washing machines stored in the database 42 in advance, such as serial numbers of the rent out washing machines, kinds of the washing machines (drum types, agitator types, pulsator types, drying capability, and so on), washing capacities (5 kg, 6 kg, - - - , 13 kg, and so on), kinds of motors (BLDC motors, induction motors, SRM motors, and so on), and so on.

The charging device 30 is connected to the communication terminal 40 with a serial data communication line, and includes means for recognizing at least one of paying means, such as a credit card, a cellular phone, and so on.

Above system enables the user to select one of the rent out washing machine 10a˜10n intended to use through a washing control related image displayed on the display means 43 of the communication terminal 40, and apply washing conditions proper to a washing object intended to wash thereto.

The washing conditions the user applies may be a clothes amount to be washed (low, low-medium, medium, medium-high, or high), a washing course program (a centrifugal washing, a preliminary washing, a vibratory washing, or a soaked washing), a washing time period, a number of washing, a number of rinsing, a spinning time period, a number of spinning, and so on.

Upon reception of the washing conditions, the control means 44 in the communication terminal reads product information on the rent out washing machine the user selects from the database 42, together with a serial number of the rent out washing machine.

Then, the control means 44 calculates washing cost with reference both to the product information on the rent out washing machine and the washing conditions the user applies, and displays the washing cost on the display means 43.

If the user notices the washing cost displayed on the communication terminal 40, and pays the washing cost through the charging device 30, the control means 44 provides the washing conditions to the rent out washing machine, together with the serial number.

If the serial number from the communication terminal 40 is the same with the serial number of its own, the rent out washing machine 10a˜10n receives the washing conditions applied thereto together with the serial number, and performs washing according to the user's washing conditions.

Or alternatively, by storing subscriber numbers in the database 42 of the communication terminal 40, subscriber based management may be made, in which use of the rent out washing machine 10a˜10n is permitted only to the subscribers stored in the communication terminal 40.

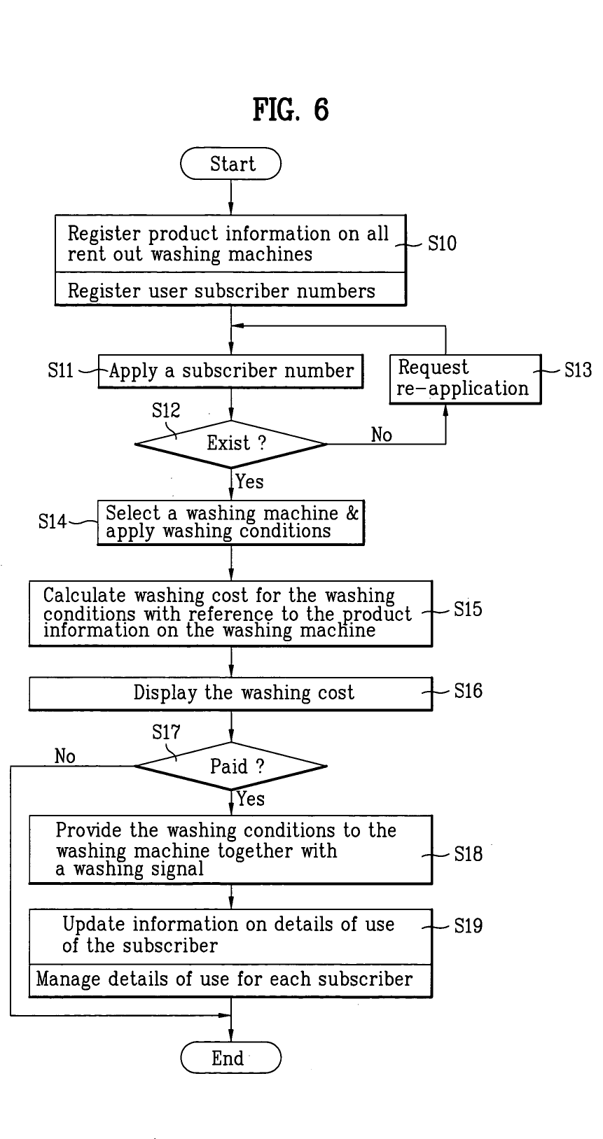

FIG. 5 illustrates a diagram showing a system of a device for integrated management of rent out washing machines in accordance with a third preferred embodiment of the present invention.

Referring to FIG. 5, the device for integrated management of rent out washing machines includes a plurality of rent out washing machines 10a˜10n, a communication terminal 40 interfaced with the rent out washing machines 10a˜10n through communication means 20, and accessible to a website a managing server 50 manages through a network, and a charging device 30 connected to the communication terminal 40 for charging washing cost of the rent out washing machines 10a˜10n.

The third embodiment of the present invention is similar to the second embodiment described with reference to FIGS. 3 and 4. The third embodiment device for integrated management of rent out washing machines further includes communication means accessible to the managing server 50 through the Internet.

In FIG. 5, even though the communication terminal 40 is shown as a PC or a notebook computer, the communication terminal 40 may be a radio mobile terminal having a web-browser stored therein so as to be accessible to the managing server 50 through a communication network, such as the Internet.

The managing server 50 operates a web site for integrated management of the rent out washing machines 10a˜10n, such as management, detail of use, diagnosis of faults, and so on. That is, the managing server 50 can control, and manage the rent out washing machines 10a˜10n by using the communication terminal 40 accessed through the Internet.

If the user accesses to the web site through the communication terminal 40, the managing server 50 provides the user with an interface screen related to washing control so that the user can enter the rent out washing machine 10a˜10n the user intends to use, and the washing conditions.

Moreover, different from the second embodiment, a database on the rent out washing machine 10a˜10n is provided to the managing server 50.

Above system enables display of the user interface screen provided from the managing server 50 on the display means 43 of the communication terminal 40, if the user accesses to the web site the managing server 50 operates by using the communication terminal 40.

Then, the user can selects one of the plurality of rent out washing machines 10a˜10n intended to use, and enters washing conditions suitable to the washing objects, through a washing control related screen displayed at the display means 43.

When the user finishes entering of the washing conditions, the managing server 50 reads product information on the rent out washing machine together with a serial number of the rent out washing machine the user selects from the database.

Then, the managing server 50 calculates washing cost with reference both to the product information on the rent out washing machine and the washing conditions the user enters, and provides to the communication terminal 40, together with the serial number of the rent out washing machine.

Then, the communication terminal 40 receives the washing cost, and the serial number from the managing server 50 through the Internet, and displays the washing cost on the display means 43.

When the user notices the washing cost displayed on the communication terminal 40, and pays the washing cost through the charging device 30, the communication terminal 40 provides the washing conditions. Then, the rent out washing machine 10a˜10n performs washing according to the washing conditions having the communication terminal 40 provided thereto.

Accordingly, the embodiment of the present invention enables to control operation of the rent out washing machines 10a˜10n selectively according to user's requirements by accessing to the web site the managing server 50 operates.

Moreover, by storing subscriber numbers in the database 31, the embodiment of the present invention may make subscriber based management, in which use of the rent out washing machine 10a˜10n is permitted only to the subscribers stored in the charging device 30.

The embodiment enables not only individual control of the rent out washing machines 10a˜10n through the managing server 50, but also management of detail of use of the rent out washing machines 10a˜10n for each of the subscribers, and provides fault diagnosis service by watching operation states of the rent out washing machines 10a˜10n in real time by communication with the communication terminal.

A method for integrated management of rent out washing machines of the present invention will be described based on above devices in accordance with embodiments of the present invention.

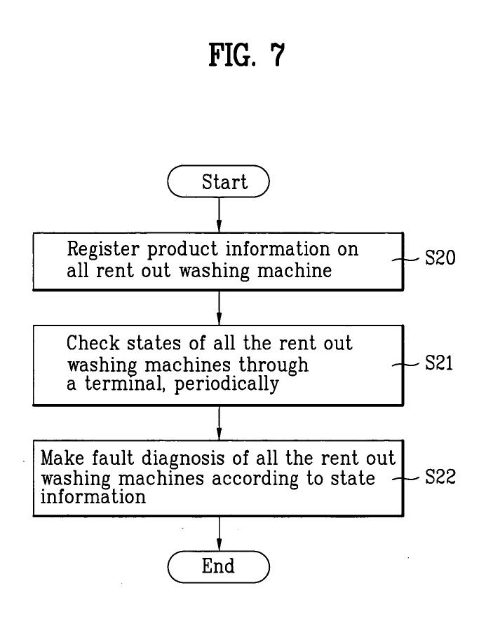

Before starting description of the method of the present invention, a method for managing details of use of the rent out washing machine will be described with reference to FIG. 6.

Referring to FIG. 6, the managing server 50 has product information on each of the rent out washing machines 10a˜10n, and each of subscriber numbers registered thereon (S10).

The user makes access to the web site the managing server 50 operates by using the communication terminal 40, and applies a subscriber number of his own thereto (S11).

Then, the managing server 50 determines the subscriber number applied thereto presently of existing on the database of the subscriber numbers (S12). As a result of the determination, if the subscriber number does not exist on the database, the managing server 50 forwards a message requesting re-application of the subscriber number (S13).

Opposite to this, if the subscriber number exists on the database, the managing server 50 provides a screen which enables the user to enter a rent out washing machine the user intends to use, and washing conditions through the communication terminal 40.

Then, the user selects the rent out washing machine intended to use, and the washing conditions of the rent out washing machine (S14).

Then, the managing server 50 calculates washing cost with reference both to the washing conditions (a clothes amount, a washing course, a washing time period, a number of washing times, a number of spinning times, a spinning time period, a number of rinsing times, and so on) having the user entered thereto, and product information on the rent out washing machine selected by the user (a kind of the washing machine, a capacity of the washing machine, a kind of motor, and so on) (S15).

The managing server 50 provides washing cost information to the communication terminal 40, and the communication terminal 40 receives, and displays the washing cost information (S16).

If the washing cost is paid through the charging device 30, the managing server 50 provides a washing signal to the communication terminal 40 (S17)(S18).

Upon reception of the washing signal from the managing server 50, the communication terminal 40 provides the washing conditions to the rent out washing machine selected by the user, together with the washing signal.

In this instance, the rent out washing machine having the washing signal received from the communication terminal becomes to be ready to perform washing according to the user's washing conditions.

The managing server 50 stores details of use of the user (an accumulated number of times of use, washing program used frequently, and so on) whenever the rent out washing machine is used, to manage details of use for each of the subscribers (S19).

For an example, the managing server 50 may provide services, such as giving free use coupons, to the users who use the rent out washing machines more than a certain number of times with reference to the details of use of the subscribers.

The integrated control of the rent out washing machines is possible through the communication terminal 40 even if no managing server 50 is provided. That is, by constructing a database 42 having all product information on the rent out washing machines, and subscriber numbers stored thereon at the communication terminal 40, the details of use of the subscribers can be managed through the communication terminal 40.

A method for controlling a state of a washing machine of the present invention will be described in detail.

The communication terminal checks operation states (changes of water levels at waster supply/drain, operation states of motors, and so on) of all the rent out washing machines 10a˜10n through the communication means 20, periodically.

In this instance, the managing server 50 has the product information on each of the rent out washing machines stored therein, and receives information on operation states of the rent out washing machines 10a˜18n through the communication terminal 40, periodically (S20) (S21), so that the managing server 50 manages operation states of the rent out washing machines. That is, the managing server 50, far from the rent out washing machines, can check operation states of the rent out washing machines 10a˜10n, to diagnosis fault of a particular rent out washing machine (S22).

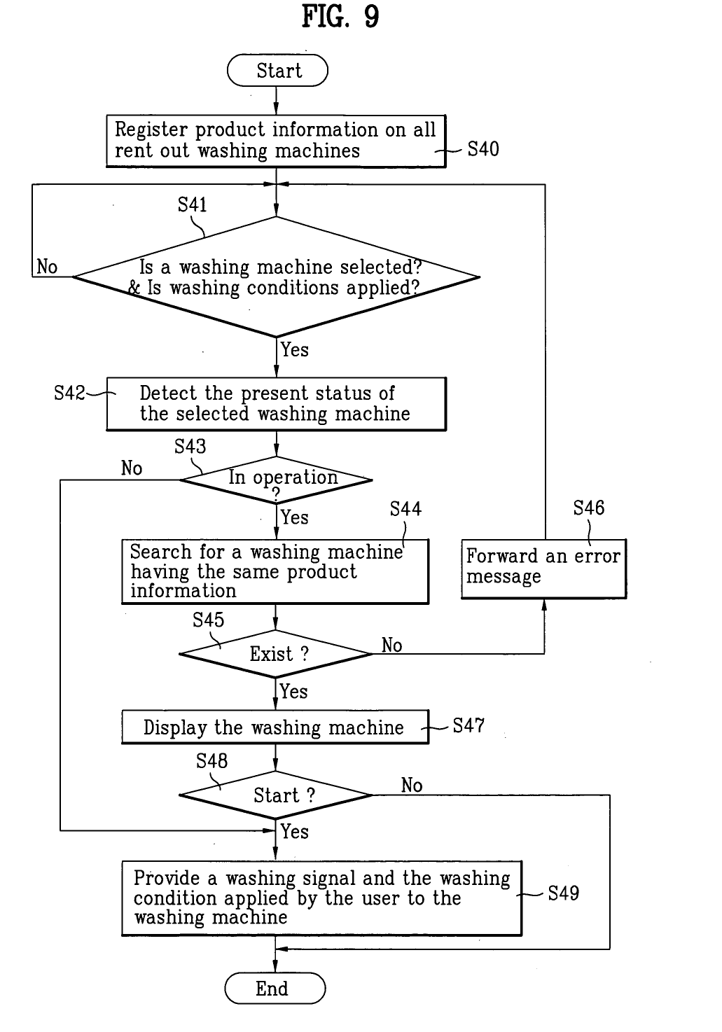

A method for integrated management of rent out washing machines in accordance with a preferred embodiment of the present invention will be described in detail, with reference to FIG. 8.

Referring to FIG. 8, the communication terminal 40 or the managing server 50 has product information on all the rent out washing machines 10a˜10n, and subscriber numbers registered thereon (S30).

If the user intending to use the rent out washing machine is a registered subscriber, the user enters user's own subscriber number through the communication terminal 40 (S31, and S32).

If the subscriber number is not among the registered subscriber numbers, a message for requesting re-entrance of the subscriber number is forwarded (S33, S34).

Opposite to this, if the subscriber number is among the registered subscriber numbers, i.e., if subscriber authorization is finished properly, after selecting the rent out washing machine the user intending to use, washing conditions of washing objects are entered (S35).

Then, washing cost is calculated and displayed, with reference both to the product information on the rent out washing machine selected by the user, and the washing conditions (S36, and S37).

When the washing cost is paid, the washing condition is provided to the rent out washing machine selected by the user, together with a washing signal (S38, and S39).

Then, the rent out washing machine receives the washing signal, and performs washing accordingly.

Opposite to this, if the user intending to use the rent out washing machine is a non-subscriber, the user may use the rent out washing machine only by charging, and being paid of the washing cost without passing through the subscriber authorization steps (S31˜S34).

That is, use of the rent out washing machine can be controlled for the subscribers, and non-subscribers, differently.

A method for integrated management of rent out washing machines in accordance with a preferred embodiment of the present invention will be described in detail, with reference to FIG. 9.

Referring to FIG. 9, the communication terminal 40 has product information on the rent out washing machine 10O˜10n registered thereon (S40).

If the user enters the rent out washing machine intending to use, and the washing conditions through the communication terminal 40 (S41), the communication terminal 40 checks the present state of the rent out washing machine selected by the user (S42).

If the rent out washing machine selected by the user is under operation, i.e., under use presently, the product information on the rent out washing machine selected by the user is compared to product information on all registered rent out washing machines (kinds of washing machines, washing capacities, kinds of motors, and so on), in a search for a rent out washing machine having the same product information on the rent out washing machine selected by the user (S43, and S44).

For an example, of the product information on the rent out washing machines, kinds and capacities are compared, for selecting a rent out washing machine having the same kind and capacity with the washing machine selected by the user.

As a result of the search, if there is no rent out washing machine having the same product information, an error message (for an example, “the washing machine ‘A’ selected by the user is under use. Select a washing machine again.”) is forwarded (S45, and S46).

Opposite to this, if a rent out washing machine having the same product information exists, a message (for an example, the washing machine ‘A’ is under use. You may use another washing machine ‘C’. Will you ?) asking if the user uses other washing machine is displayed (S47).

Noticing that a washing machine having product information the same with the product information of the washing machine selected by the user is selected, if the user determines to use the washing machine (S48), the washing signal and the washing conditions entered by the user are provided to the rent out washing machine (S49).

The rent out washing machine, having the washing signal received from the communication terminal 40, becomes ready to perform washing according to the washing conditions.

As has been described, the device and method for integrated management of rent out washing machines have the following advantages.

First, the management of details of use of rent out washing machines installed at a particular place (such as dormitory, or the like) for each of users, and states of the rent out washing machines by means of the communication terminal (PC), or the managing server far from the rent out washing machines permits to satisfy a variety of requirements of the users in a position of a person in the business (manager), and increase income, accordingly.

The central integrated management of the rent out washing machines by means of PC or server, not only resolves the inconvenience and difficulty in purchase, installation, and movement of the washing machine in a position of the users, but also enables to use washing machines of new models anytime.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A device for integrated management of rent out washing machines comprising:
a plurality of rent out washing machines; and
a charging device connected to the plurality of rent out washing machines, for controlling operation of one of the rent out washing machines the user intends to use, if washing cost is paid for using the one rent out washing machine.

2. The device as claimed in claim 1, wherein the charging device communicates with the plurality of rent out washing machines by using communication means either of a radio communication type, or of a wire communication type.

3. The device as claimed in claim 2, wherein each of the rent out washing machines and the charging device includes input/output ports for the communication means for making bilateral data communication.

4. The device as claimed in claim 1, wherein the rent out washing machine includes;
a data receiving means for receiving washing conditions of a washing object a user intends to wash,
display means for displaying a washing progress, and
control means for receiving the washing conditions from the data receiving means, and providing the washing conditions to the charging device together with a serial number of the washing machine itself, and controlling washing according to the washing condition applied by the user in response to a washing signal from the charging device.

5. The device as claimed in claim 1, wherein the charging device includes means for recognizing at least one of paying means, such as credit card, cellular phone, and so on.

6. The device as claimed in claim 5, wherein the charging device further includes;
a database for storing product information on each of the plurality of rent out washing machines including a serial number, a kind of the washing machine, a capacity of the washing machine, a kind of motor,
control means for reading product information on the washing machine of the serial number if the serial number and the washing conditions are received from the rent out washing machine, calculating washing cost with reference both to the product information on the washing machine, and the washing conditions, and providing a washing signal to the rent out washing machine if payment of the washing cost is finished, and
display means for displaying the washing cost calculated by the control means.

7. A device for integrated management of rent out washing machines comprising:
a plurality of rent out washing machines;
a charging device for charging washing cost of the rent out washing machine; and
a communication terminal connected to the plurality of rent out washing machines and the charging device, for controlling operation of one of the rent out washing machines the user intends to use, if the washing cost is paid through the charging device for using the one rent out washing machine.

8. The device as claimed in claim 7, wherein the communication terminal communicates with the plurality of rent out washing machines by using communication means either of a radio communication type, or of a wire communication type.

9. The device as claimed in claim 8, wherein each of the rent out washing machines and the communication terminal includes input/output ports for the communication means for making bilateral data communication.

10. The device as claimed in claim 7, wherein the communication terminal is connected to the charging device with serial data communication line.

11. The device as claimed in claim 7, wherein the communication terminal includes;
a database for storing product information on each of the plurality of rent out washing machines including a serial number, a kind of the washing machine, a capacity of the washing machine, a kind of motor,
data receiving means for selecting one from the rent out washing machines intended to use, and receiving washing conditions of washing objects intended to wash,
display means for displaying a screen of washing control related interface for selection of the rent out washing machine and applying the washing cost, and the washing cost, and
control means for calculating the washing cost with reference both to the product information on the rent out washing machine stored in the database and the washing conditions if the user applies the rent out washing machine intended to use and the washing conditions through the data receiving means, and providing a washing signal to the rent out washing machine if charging, and reception of the washing cost is finished through the charging device.

12. The device as claimed in claim 7, wherein the communication terminal is one selected from a notebook computer, a personal computer, a mobile terminal.

13. The device as claimed in claim 7, wherein the charging device includes means for recognizing at least one of paying means, such as credit card, cellular phone, and so on.

14. A device for integrated management of rent out washing machines comprising:
a plurality of rent out washing machines;
a charging device for charging washing cost of the rent out washing machine;
a managing server for operating a web site for providing remote control of the rent out washing machines and integrated management service; and
a communication terminal accessible to the managing server through a communication network for enabling the remote control and integrated management of the rent out washing machines, and connected to the plurality of rent out washing machines and the charging device, for controlling operation of one of the rent out washing machines the user intends to use, if the washing cost is paid through the charging device for using the one rent out washing machine.

15. The device as claimed in claim 14, wherein the communication terminal communicates with the plurality of rent out washing machines by using communication means either of a radio communication type, or of a wire communication type.

16. The device as claimed in claim 15, wherein each of the rent out washing machines and the communication terminal includes input/output ports for the communication means for making bilateral data communication.

17. The device as claimed in claim 14, wherein the communication terminal is connected to the charging device with serial data communication line.

18. The device as claimed in claim 14, wherein the communication terminal one of a notebook computer, a personal computer, a radio mobile terminal, having a web browser stored therein for access to the managing server through a communication network.

19. The device as claimed in claim 14, wherein the communication terminal includes;
display means for displaying a screen of washing control related interface and the washing cost from the managing server,
data receiving means for selecting a rent out washing machine the user intends to use with reference to the screen of washing control related interface, and entering the washing conditions of washing objects to be washed, and
control means for displaying the washing cost calculated at the managing server through data communication with the managing server when the user applies the rent out washing machine the user intends to use, and the washing conditions, and providing a washing signal to the rent out washing machine if the washing cost is paid.

20. The device as claimed in claim 14, wherein the managing server includes a database having product information on each of the plurality of rent out washing machines stored therein, the product information including a serial number, a kind of the washing machine, a capacity of the washing machine, a kind of motor of the rent out washing machine, for calculating the washing cost of the rent out washing machine to be used by the user through communication with the communication terminal.

21. The device as claimed in claim 14, wherein the charging device includes means for recognizing at least one of paying means, such as credit card, cellular phone, and so on.

22. A method for integrated management of rent out washing machines, comprising the steps of:
receiving washing conditions of washing object to be washed from one of the rent out washing machines selected by the user;
calculating washing cost of the rent out washing machine with reference both to product information on the rent out washing machine selected by the user, and the washing conditions received; and
controlling to start operation of the rent out washing machine if the washing cost is paid.

23. The method as claimed in claim 22, wherein the product information on the rent out washing machine includes a serial number, a kind of the washing machine, a capacity of the washing machine, a kind of motor of the rent out washing machine.

24. The method as claimed in claim 22, wherein the washing conditions of the washing object are cycle time periods, and numbers of cycles for washing cycle, rinsing cycle, and spinning cycle, respectively.

25. A method for integrated management of rent out washing machines, comprising the steps of:
making access to a managing server which provides remote control, and integrated management services of the rent out washing machines;
receiving product information on the rent out washing machine selected by a user, and washing conditions of a washing object to be washed if the user intending to access presently is a subscriber registered already;
calculating washing cost of the rent out washing machine with reference both to the product information on the rent out washing machine and the washing conditions received; and
controlling to start operation of the rent out washing machine if the washing cost is paid.

26. The method as claimed in claim 25, wherein the product information on the rent out washing machine includes a serial number, a kind of the washing machine, a capacity of the washing machine, a kind of motor of the rent out washing machine.

27. The method as claimed in claim 25, wherein the washing conditions of the washing object are cycle time periods, and numbers of cycles for washing cycle, rinsing cycle, and spinning cycle, respectively.

28. A method for integrated management of rent out washing machines, comprising the steps of:
receiving washing conditions of a washing object to be washed from one of the rent out washing machines selected by the user;
determining the present status of use of the rent out washing machine selected by the user;
searching for a rent out washing machine having product information the same with rent out washing machine selected by the user;
if there is the rent out washing machine having product information the same with the rent out washing machine selected by the user, calculating washing cost of the rent out washing machine with reference both to the product information on the rent out washing machine and the washing conditions received; and
controlling to start operation of the rent out washing machine if the washing cost is paid.

29. The method as claimed in claim 28, wherein the product information on the rent out washing machine includes a serial number, a kind of the washing machine, a capacity of the washing machine, a kind of motor of the rent out washing machine.

30. The method as claimed in claim 28, wherein the washing conditions of the washing object are cycle time periods, and numbers of cycles for washing cycle, rinsing cycle, and spinning cycle, respectively.

31. A method for integrated management of rent out washing machines, comprising the steps of:
making access to a managing server which provides remote control, and integrated management services of the rent out washing machines;
receiving details of use, and state information of the rent out washing machine the user used if the user intending to access presently is a subscriber registered already;
renewing the details of use for each of users according to the details of use of the rent out washing machine received; and
making fault diagnosis of the rent out washing machines through the state information on the rent out washing machines received.
